(19) United States
(12) Patent Application Publication
(10) Pub. No.: US 2004/0208622 A1
(43) Pub. Date: Oct. 21, 2004

(54) Method and apparatus for signal conditioning of optical signals for fiber-optic transmission

(75) Inventors: Diego Fernando Grosz, Middletown, NJ (US); Stefan Hunsche, Jersey City, NJ (US); Gregory Raybon, Shrewsbury, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/139,058

(22) Filed: May 3, 2002

(51) Int. Cl. H04J 14/02; H04B 10/00

(52) U.S. Cl. 398/160

(57) ABSTRACT

The invention comprises a method and apparatus for passive optical conditioning and format conversion of RZ optical signals including, but not limited to, conversion from RZ to CRZ or to CSRZ, using a nonlinear device. The invention generates signals that may be optimized to improve transmission performance, receiver performance, and/or spectral efficiency of the optical transmission system. A method for passively generating an optical carrier-suppressed return-to-zero (CSRZ) signal according to the present invention includes, propagating an optical RZ signal through a nonlinear element, the nonlinear element configured to broaden the optical RZ signal such that the optical RZ signal is phase shifted by approximately 3Π/2.

### FIELD OF THE INVENTION

This invention relates to the field of fiber-optic transmission systems, and more specifically, to return-to-zero encoded data transmission.

### BACKGROUND OF THE INVENTION

High speed fiber-optic data transmission over long distances in many cases relies on return-to-zero (RZ) encoding of optical signals, i.e. transmission of well-separated light pulses within each bit-slot of the data signal. Return-to-zero coding typically improves the receiver sensitivity at the end point of the optical link, as compared with non-return-to-zero (NRZ) signals, and generally improves the transmission performance in the nonlinear transmission regime (long spans, optical amplification). However, regular RZ signals typically require a larger optical bandwidth than NRZ signals. Further improvements of the transmission properties can be achieved by specific conditioning of RZ signals such as “chirped-RZ” (CRZ) or “carrier-suppressed RZ” (CSRZ). Chirped RZ signals generally have a larger optical bandwidth than regular RZ, leading to faster pulse spreading in a dispersive transmission fiber and therefore reduced nonlinear penalties; while CSRZ reduces the optical bandwidth over regular RZ by an additional phase modulation, allowing higher spectral efficiency in dense wavelength-division multiplexed (DWDM) systems, and often improving nonlinear transmission penalties as well. Depending on the exact configuration of the system, in terms of reach, capacity, signal power, etc., either transmission format may provide the best overall performance. CRZ and CSRZ signals can be generated from regular RZ signals by active phase modulation using an (additional) external high-speed modulator. This approach adds considerable cost and complexity to the fiber-optic transmitter, while different types or configurations of modulator will be required to generate different transmission formats.

### SUMMARY OF THE INVENTION

The invention comprises a method and apparatus for passive optical conditioning and format conversion of return-to-zero (RZ) optical signals including, but not limited to, conversion from RZ to chirped return-to-zero (CRZ) or to carrier-suppressed return-to-zero (CSRZ), using a nonlinear device. The invention generates signals that may be optimized to improve transmission performance, receiver performance, and/or spectral efficiency of the optical transmission system.

In one embodiment of the present invention, a method for passively generating a conditioned optical return-to-zero (RZ) signal for improved transmission includes, propagating an optical RZ signal through a nonlinear element, the nonlinear element configured to spectrally broaden the optical RZ signal. Alternatively, the method can further include, filtering the optical RZ signal after the propagating, such that the filtered optical RZ signal has a different optical bandwidth then the original optical RZ signal and amplifying the optical RZ signal.

In another embodiment of the present invention, an apparatus for passively generating an optical CSRZ signal for improved transmission includes, an RZ transmitter, for transmitting an optical RZ signal, an optical amplifier, for amplifying the optical RZ signal from the RZ transmitter such that a gain parameter of each of two adjacent modulation sidebands of the amplified optical RZ signal are similar, a nonlinear element, for broadening the amplified optical RZ signal, such that the optical RZ signal is phase shifted by approximately 3Π/2, and a filter, for filtering the broadened optical RZ signal, such that the filtered optical RZ signal requires a lower optical bandwidth than the original optical RZ signal.

### BRIEF DESCRIPTION OF THE DRAWINGS

The teachings of the present invention can be readily understood by considering the following detailed description in conjunction with the accompanying drawings, in which:

FIG. 1 depicts a block diagram of one embodiment of a system for passively generating carrier-suppressed signals;

FIG. 2 depicts a block diagram of one embodiment of a multi-channel system for passively generating carrier-suppressed signals;

FIG. 3 graphically depicts stages of propagation of an optical signal from a data transmitter through the carrier-suppression system of FIG. 1; and

FIG. 4 graphically depicts improved dispersion tolerance for CS-RZ signals.

To facilitate understanding, identical reference numerals have been used, where possible, to designate identical elements that are common to the figures.

### DETAILED DESCRIPTION OF THE INVENTION

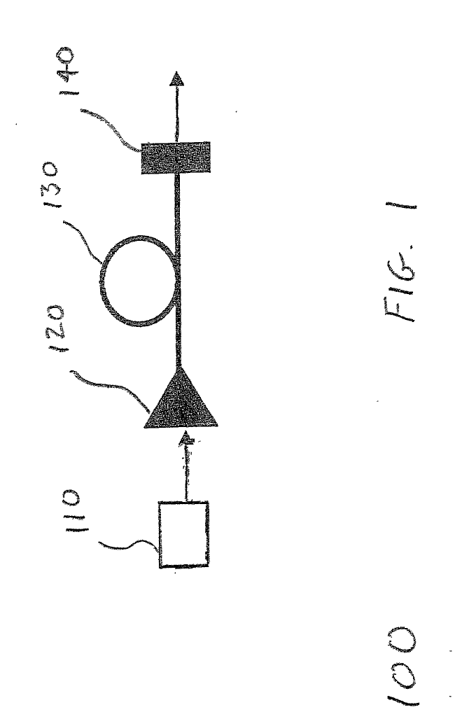

The system 100 of FIG. 1 will be described in detail within the context of a system for the conversion of return-to-zero (RZ) signals to carrier-suppressed return-to-zero (CSRZ) signals. However, it will be appreciated by those skilled in the art that the subject invention may be advantageously employed in systems for the optical conditioning and format conversion of RZ optical signals including, but not limited to, conversion from RZ to chirped return-to-zero (CRZ) or to CSRZ, using a nonlinear device. Thus, it is contemplated by the inventors, that the subject invention has broad applicability beyond the system described herein. The invention may be used to generate signals that may be optimized to improve transmission performance, receiver performance, and/or spectral efficiency of the optical transmission system.

FIG. 1 depicts a block diagram of one embodiment of a system for signal conditioning of optical signals for fiber-optic transmission. The system 100 of FIG. 1 depicts a system for passively generating CSRZ signals using an optical nonlinear element. The system 100 of FIG. 1 includes an RZ data transmitter, an optical amplifier, a nonlinear fiber, and a filter. Briefly stated, optical signals from the RZ data transmitter are optically amplified by the optical amplifier and pass through the nonlinear fiber. The filter then selects a modulated signal consisting of sidebands at plus/minus the bit rate divided by 2 (BR/2) relative to the new signal center frequency in order to create a carrier-suppressed signal with reduced optical bandwidth.

The carrier suppression system 100 of FIG. 1 includes an RZ data transmitter (illustratively a pulse carver data transmitter) 110, an optical amplifier (illustratively an erbium-doped fiber amplifer (EDFA)) 120, a nonlinear element (illustratively a 2 km high-nonlinear fiber (HNLF)) 130, and a filter (illustratively an arrayed waveguide grating (AWG) filter) 140. Although the elements of system 100 in FIG. 1 are depicted as specific devices, other such devices that perform substantially similar functions as the specified elements can be substituted. For example, the RZ data transmitter 110 of the carrier suppression system 100 of FIG. 1 can be a mode-locked laser data transmitter or an electro-absorption modulator data transmitter; the optical amplifier 120 can be an erbium doped fiber amplifier, a Raman fiber amplifier, or a parametric fiber amplifier; the nonlinear element 130 can be a semiconductor optical amplifier, a highly-nonlinear microstructured (“photonic bandgap”) fiber, or a Chalcogenide optical fiber; and the filter 140 can be a tunable bandpass filter, a dispersion-free fiber-Bragg grating filter, or a dispersion fiber-Bragg grating filter and the like.

In the system 100 of FIG. 1, optical signals from the RZ data transmitter 110 are input to the optical amplifier 120. The signal is amplified by the optical amplifier 120 and propagates through the nonlinear element 130. The nonlinear element 130 has a small effective area, typically around 11 microns squared, and small negative dispersion (D<0). The effect of the small effective area is an increase in intensity, which improves the nonlinear effects within the nonlinear element 130. During propagation through the nonlinear element 130, self phase modulation (SPM) broadens the optical spectrum of the signal and leads to the accumulation of a nonlinear phase shift. In this embodiment, spectral broadening due to SPM is symmetrical with regard to the input frequency, such that a carrier-suppressed signal can be obtained by placing a BPF at a positive or negative offset. When the accumulated nonlinear phase at the pulse maximum equals 3Π/2, the optical signal spectrum displays a pronounced minimum at the center (carrier) frequency. The carrier signal is at this point, effectively suppressed.

Subsequently, the amplified signal power is adjusted such that two adjacent modulation sidebands gain approximately equal amplitude. The center frequency between the two adjacent sidebands is the new carrier-suppressed return-to-zero (CSRZ) signal's center frequency (f_{CS-RZ}). The f_{CS-RZ} is located at the original carrier frequency plus or minus fₘₐₓ, where fₘₐₓ=(N+½)×BR. In the equation for fₘₐₓ, N is equal to the number of sidebands between the original carrier frequency and f_{CS-RZ}, and BR is equal to the bit rate of the optical signal. Whether to add or subtract fₘₐₓ from the original carrier frequency depends on how the amplified signal power is adjusted, which subsequently determines on what side of the original carrier frequency f_{CS-RZ} is located. It should be noted though, that in some instances, both the positive and the negative offsets are utilized.

The filter 140 has a wavelength centered at f_{CS-RZ}. The filter 140 selects a modulated signal consisting of sidebands at plus/minus BR/2 relative to the f_{CS-RZ}. The resultant CS-RZ signal requires only half of the optical bandwidth, and as such, improves the spectral efficiency of subsequent transmission systems.

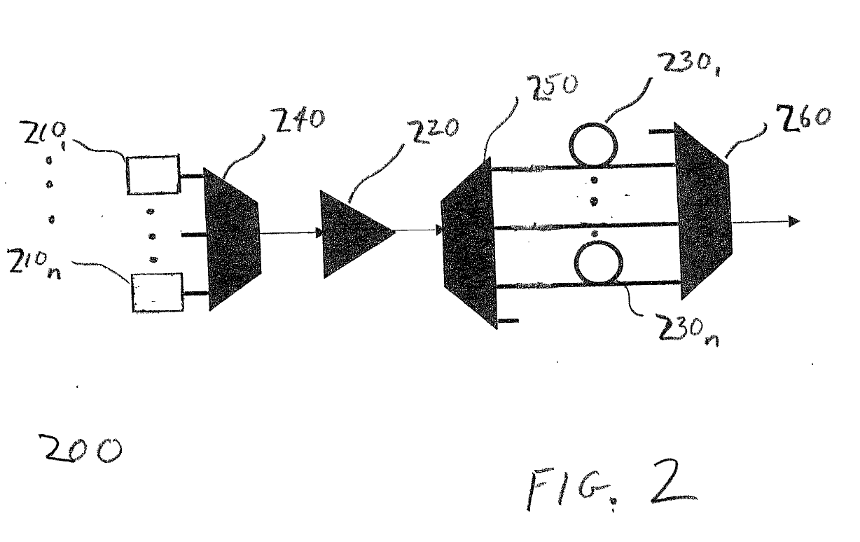

In another embodiment of the present invention, the carrier-suppression system is implemented in multi-channel systems. FIG. 2 depicts a block diagram of one embodiment of a multi-channel system 200 for passively generating carrier-suppressed signals in multi-channel format using optical nonlinear elements. The carrier suppression system 200 includes a plurality of RZ data transmitters 210₁-210ₙ (collectively 210), an optical amplifier 220, a plurality of nonlinear elements (illustratively high-nonlinear fibers (HNLF)) 230₁-230ₙ (collectively 230), a first multiplexer 240, a demultiplexer 250, and a second multiplexer 260. In the embodiment of FIG. 2, the second multiplexer 260 is depicted as an Arrayed Waveguide Grating (AWG) filter. Briefly stated, optical signals from the data transmitters 210 are combined in the first multiplexer 240 and are optically amplified by the optical amplifier 220. The combining of the optical signals from the data transmitters 210 by the multiplexer 240 allow the optical signals to be amplified by a single optical amplifier 220, thus reducing the cost of the system. The optical signals are subsequently separated by the demultiplexer 250 and individually propagate through the nonlinear element 230. The second multiplexer 260 then combines the optical signals and creates a modulated signal consisting of sidebands at plus/minus BR/2 relative to the new signal center frequency. As previously described, propagation through the nonlinear element 230 causes self phase modulation (SPM) of the signals, which broadens the optical spectrum and leads to the accumulation of nonlinear phase shifts. When the accumulated nonlinear phase at the pulse maximum equals 3Π/2, the optical signal spectrums display a pronounced minimum at the center (carrier) frequency. The carrier signals are at this point, effectively suppressed.

Subsequently, the amplified signal power is adjusted such that two adjacent modulation sidebands for each signal gain approximately equal amplitude. The center frequency between the two adjacent sidebands is each new CS-RZ signal's center frequency (f_{CS-RZ}). The f_{CS-RZ} is located at the original carrier frequency plus or minus fₘₐₓ, where fₘₐₓ=(N+½)×BR. In the equation for fₘₐₓ, N is equal to the number of sidebands between the original carrier frequency and f_{CS-RZ}, and BR is equal to the bit rate of the optical signal. Whether to add or subtract fₘₐₓ from the original carrier frequency depends on how the amplified signal power is adjusted, which subsequently determines on what side of the original carrier frequency f_{CS-RZ} is located. It should be noted though, that in some instances, both the positive and the negative offsets are utilized.

The second multiplexer 260 has a wavelength centered at f_{CS-RZ}. The second multiplexer 260 creates a modulated signal consisting of sidebands at plus/minus BR/2 relative to the f_{CS-RZ}. The resultant CS-RZ signal requires only half of the optical bandwidth, and as such, improves the efficiency of subsequent transmission systems.

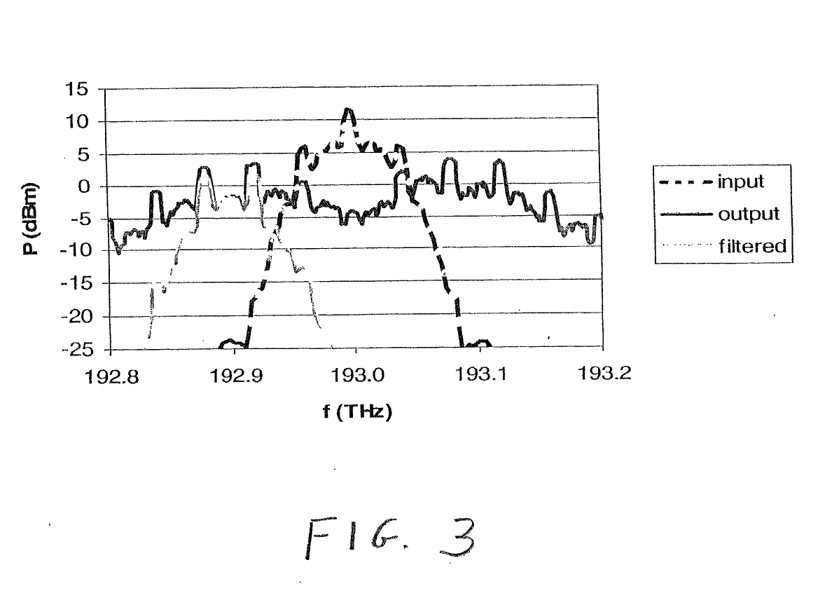

FIG. 3 graphically depicts the stages of propagation of an optical signal from a data transmitter 110 through the carrier suppression system 100 of FIG. 1. The principle of the carrier suppression system 100 is illustrated for data of 40 Gb/s at 18 dBm of power from the pulse carver data transmitter 110. It should be noted that the present invention can be applied to optical signals with other data rates and other powers.

The input curve depicts the spectrum of the optical signal from the 40 Gb/s data transmitter 110, demonstrating the strong cw-laser line at the center. The output curve depicts the broaden spectrum after transmission through the nonlinear element 130, demonstrating the effective suppression of the carrier frequency. The filtered curve depicts the spectrum after transmission through the filter 140. In this case, the AWG filter 140 has a 55 GHz 3 dB bandwidth located at 100 GHz offset from the original carrier frequency. As depicted in FIG. 3, it is evident that the 40 Gb/s data is now contained in a bandwidth only slightly larger than the bit rate, thus the spectral efficiency has nearly doubled.

The result of data transmission through the system 100 of FIG. 1 is a CSRZ optical signal. The CSRZ optical signal demonstrates several advantages over signals that propagate containing the carrier signal. Some of the advantages include improved nonlinear transmission performance, improved spectral efficiency, and improved tolerance to optical filtering and dispersion.

In addition, the nonlinear transfer function of the signal conditioning system of FIG. 1 can optically ‘regenerate’ the signal, and significantly improve the signal quality, as measured by the extinction ratio (i.e. ratio between light intensity in “ones” and “zeros”). For any system implementation, this will allow less stringent requirements on the preceding RZ data modulators, and the utilization of lower cost components. An improvement of more than 10 dB in the extinction ratio of a typical modulator, ER of 12 dB at 40 GHz, is obtained by using a CSRZ signal in accordance with the invention.

The noise in optically amplified transmission systems is dominated by the beat noise between signal light and amplified spontaneous emission (ASE) of the optical amplifiers. As such, insufficient suppression of “zeros” in the data stream will cause a noise floor that is proportional to the signal leakage in the zeros. The improvement in the extinction ratio in the system 100 of FIG. 1, effectively suppresses this noise contribution and therefore, improves the OSNR performance of the signal after propagation through the EDFA. At low OSNR, the typical operating region of long-haul systems, there is a slight improvement of about 0.5 dB in OSNR for the CS-RZ signal, or about 1 dB in Q-factor at fixed OSNR. There is though, a penalty for the CS-RZ signal at high OSNR due to the filtering in the system. At high OSNR, the Q-factor becomes nonlinear and begins to level-off. The filtering system can be optimized to minimize this penalty.

The Q-factor for a CS-RZ signal with added inter symbol interference (ISI) is even more improved. In a case where an additional signal distortion in the form of 8 ps of differential group delay (DGD) is incorporated in the signal, the resultant improvement for the CS-RZ signal in OSNR is now 2 dB. The additional improvement can be attributed to the fact that the suppression of a narrow-line carrier signal reduces the coherence length of the signal to that of the pulse duration which prevents coherent interaction between adjacent pulses in the data stream, subsequently suppressing ISI in the optical domain.

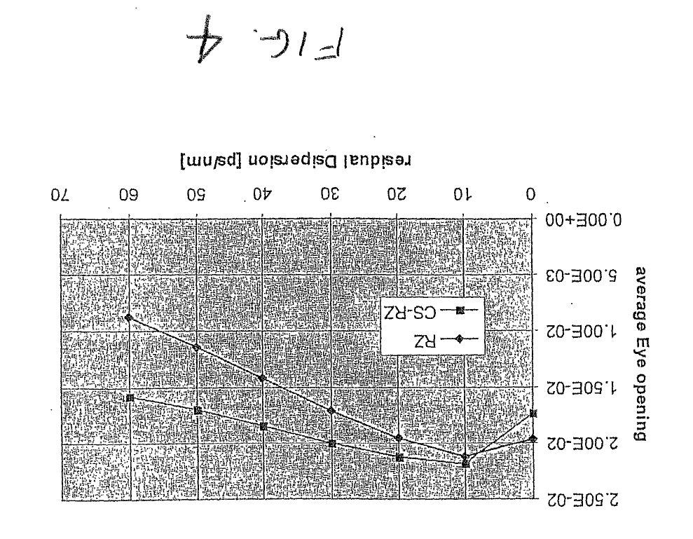

FIG. 4 graphically depicts the improved dispersion tolerance for CSRZ signals. As depicted in FIG. 1, the resulting CSRZ signals occupy a smaller bandwidth than the original pulses from the pulse carver data transmitter 110. These factors lead to a reduced sensitivity of the CSRZ signal to residual (uncompensated) dispersion in fiber transmissions. In linear systems, pulse broadening leading to signal distortions due to ISI is proportional to the residual dispersion multiplied by the signal bandwidth. As depicted in FIG. 4, shown by the average eye opening versus residual dispersion, the CSRZ signal is significantly less effected by ISI than the RZ signal.

In another embodiment of the invention, a bandpass filter has several outputs corresponding to positive and negative offsets of the broadened signal to create two redundant signals for 1+1 protection implementation.

In another embodiment of the invention other nonlinear elements, such as semiconductor optical amplifiers, are used to broaden the signal from the data transmitter. In this case an asymmetrical spectral broadening is obtained and a CS-RZ signal at only one side of the initial signal frequency is produced.

In another embodiment of the invention a bandpass filter would be centered on any of the clock lines to generate a “conditioned” RZ signal, after signal broadening. This allows for CSRZ to RZ conversion if desired, or RZ to CRZ conversion with improvement in extinction ratio.

In another embodiment of the invention the optical bandpass of a bandpass filter would be chosen wider than the optical bandwidth of the original signal to generate pulses with excess bandwidth that spread faster upon propagation in a fiber and allow “pseudo-linear” transmission for CRZ.

In any of the embodiments of the invention, a BPF at the initial signal frequency is optionally added, to provide a feedback signal to set the operating gain of the optical amplifier, by minimizing the optical power at signal frequency, f_{—}0.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method for passively generating a conditioned optical return-to-zero (RZ) signal for improved transmission, comprising:
propagating an optical RZ signal through a nonlinear element, said nonlinear element configured to spectrally broaden said optical RZ signal.

2. The method of claim 1, further comprising filtering said optical RZ signal after said propagating, such that the filtered optical RZ signal has a different optical bandwidth then the original optical RZ signal.

3. The method of claim 1, further comprising amplifying said optical RZ signal.

4. A method for passively generating an optical carrier-suppressed return-to-zero (CSRZ) signal for improved transmission, comprising:
propagating an optical RZ signal through a nonlinear element, said nonlinear element configured to broaden said optical RZ signal such that said optical RZ signal is phase shifted by approximately 3Π/2 .

5. The method of claim 4, further comprising:
amplifying said optical RZ signal prior to said propagating; and
adjusting the amplifying power, such that a gain parameter of each of two adjacent modulation sidebands of said amplified optical RZ signal are similar.

6. The method of claim 4, further comprising:
filtering said optical RZ signal, such that the filtered optical RZ signal requires a lower optical bandwidth than the original optical RZ signal.

7. A method for passively generating an optical chirped return-to-zero (CRZ) signal for improved transmission, comprising:
propagating an optical RZ signal through a nonlinear element, said nonlinear element configured to spectrally broaden said optical RZ signal; and
filtering said optical RZ signal, such that the filtered optical RZ signal has a larger optical bandwidth than the original optical RZ signal.

8. An apparatus for passively generating an optical CSRZ signal for improved transmission, comprising:
an RZ transmitter, for transmitting an optical RZ signal;
an optical amplifier, for amplifying the optical RZ signal from said RZ transmitter such that a gain parameter of each of two adjacent modulation sidebands of said amplified optical RZ signal are similar;
a nonlinear element, for broadening the amplified optical RZ signal, such that the optical RZ signal is phase shifted by approximately 3Π/2; and
a filter, for filtering said broadened optical RZ signal, such that the filtered optical RZ signal requires a lower optical bandwidth than the original optical RZ signal.

9. The apparatus of claim 8, wherein said RZ transmitter is a pulse carver data transmitter.

10. The apparatus of claim 8, wherein said RZ transmitter is a mode-locked laser data transmitter.

11. The apparatus of claim 8, wherein said RZ transmitter is an electro-absorption modulator data transmitter.

12. The apparatus of claim 8, wherein said nonlinear element is a semiconductor optical amplifier.

13. The apparatus of claim 8, wherein said nonlinear element is an optical fiber.

14. The apparatus of claim 13, wherein said optical fiber is an optical fiber with a small negative dispersion.

15. The apparatus of claim 14, wherein said optical fiber is with a small negative dispersion is a highly-nonlinear fiber.

16. The apparatus of claim 13, wherein said optical fiber is an optical fiber with a small effective area.

17. The apparatus of claim 16, wherein said optical fiber with a small effective area is a highly-nonlinear microstructured (“photonic bandgap”) fiber.

18. The apparatus of claim 13, wherein said optical fiber is a Chalcogenide optical fiber.

19. The apparatus of claim 8, wherein said optical amplifier is an erbium-doped fiber amplifier.

20. The apparatus of claim 8, wherein said optical amplifier is a parametric fiber amplifier.

21. The apparatus of claim 8, wherein said optical amplifier is a Raman fiber amplifier.

22. The apparatus of claim 8, wherein said optical amplifier is a semiconductor optical amplifier.

23. The apparatus of claim 8, wherein said filter is a bandpass filter.

24. The apparatus of claim 23, wherein said bandpass filter is an arrayed waveguide grating filter.

25. The apparatus of claim 23, wherein said bandpass filter is an interleaver filter

26. The apparatus of claim 23, wherein said bandpass filter is a dispersion-free fiber-Bragg grating filter.

27. The apparatus of claim 23, wherein said bandpass filter is a dispersive fiber-Bragg grating filter.

28. The apparatus of claim 23, wherein said bandpass filter is a tunable bandpass filter.

29. A multi-channel system for passively generating optical CSRZ signals for improved transmission, comprising:
a plurality of RZ transmitters, for transmitting optical RZ signals;
a first multiplexer, for combining the optical RZ signals from said plurality of RZ transmitters;
an optical amplifier, for amplifying the combined optical RZ signals, such that a gain parameter of each of two adjacent modulation sidebands of each of said amplified optical RZ signals are similar;
a demultiplexer, for separating the amplified optical RZ signals;
a plurality of nonlinear elements, for broadening the separated optical RZ signals, such that each of the separated optical RZ signals are phase shifted by approximately 3Π/2; and
a second multiplexer, for combining the broadened optical RZ signals from said plurality of nonlinear elements and for filtering the broadened optical RZ signals such that the filtered broadened optical RZ signals require a lower optical bandwidth than the original optical RZ signals.

30. The multi-channel system of claim 29, wherein said second multiplexer is an arrayed waveguide grating filter.
